(19) United States
(12) Patent Application Publication
(10) Pub. No.: US 2013/0024437 A1
(43) Pub. Date: Jan. 24, 2013

(54) ACTIVITY RECORDAL METHOD AND SYSTEM

(71) Applicants: Robert George Stevens, Yarraville (AU); Garry Richard Lea, Wamboin (AU); Scott Charles William Buchanan, Hampton (AU)

(72) Inventors: Robert George Stevens, Yarraville (AU); Garry Richard Lea, Wamboin (AU); Scott Charles William Buchanan, Hampton (AU)

(21) Appl. No.: 13/511,430

(22) PCT Filed: Nov. 22, 2010
(86) PCT No.: PCT/AU2010/001568

§ 371 Date: Oct. 1, 2012

(30) Foreign Application Priority Data
Nov. 23, 2009 (AU) 2009905743

(51) Int. Cl. G06F 17/30

(52) U.S. Cl. 707/705; 707/E17.009

(57) ABSTRACT

An activity recordal method comprising electronically monitoring for occurrence of events pertaining to one or more activities, electronically associating information relating to said events with respective activities, recording said information relating to said events with data indicative of said respective activities in a database, electronically generating reporting data from said information relating to said events recorded in said database, and electronically outputting said reporting data.

### FIELD OF THE INVENTION

The present invention relates to an activity recordal method and system, of particular but by no means exclusive application in time recordal and billing applications. This application is based on and claims the benefit of the filing date of Australian application no. 2009905743 filed 23 Nov. 2009, the content of which as filed is incorporated herein by reference in its entirety.

### BACKGROUND OF THE INVENTION

Existing recordal systems generally record durations of times associated with respective activities or merely instances of the activities. The recordal systems which record durations of time generally employ a stopwatch function, which is operable by a user to be manually started and stopped whilst performing a particular activity or event. For example, the user may make a phone call and record its duration by manually starting and stopping the stopwatch at the commencement and completion of the phone call. However, there are problems with the accuracy of such a time recordal system especially in relation to the user failing to remember to start/stop the stopwatch at the commencement/completion of the event and not recording details of the event accurately. Also, the user may waste considerable time amending and manipulating the record of the durations of times to better reflect the actual time spent, and such inaccurate time recording is therefore by its nature contestable and liable to potentially result in inaccurate billing and inaccurate gathering of business intelligence. Furthermore, allowing the user to edit the duration of time may create the possibility of over recording time (e.g. ‘padding’ which, where time-based billing is used will lead to client overcharging), under-recording of time (e.g. ‘false efficiency’), or simple failure to record.

Also, the introduction and existence of multiple stopwatches in many modern enterprise-level time recordal systems, although intended to assist in improving accuracy for each activity recorded, can, paradoxically, decrease overall time recorded because of user overload in attempting to manage and use multiple stopwatch instances.

One existing time recordal system provides an automated stopwatch function to improve accuracy of time recording. For example, such a system may trigger the automated stopwatch function to start recording a duration of time when a user starts to write a new email on his/her computer and may trigger the stopwatch to stop recording the duration of time when the user sends the email. However, while such automation provides a more accurate time recordal system it does not assist the user in minimising time subsequently spent associating recorded durations of time with activities to be billed, and assumes that the user has not engaged in another task during the intervening period.

Furthermore, with the existing time recordal systems, it may not always be possible to allocate or associate the recorded durations of time to respective billable activities thus resulting in lost or abandoned durations of time and lost billings. In addition, as the user must vet and associate recorded durations of time, this system may be subject to user manipulation, such as the user not associating particular durations of time accurately. Thus, as a consequence of these cumulative sources of error, the resultant collection of derived durations of time, even if based upon automated timings, may not provide an accurate gauge as to how the user spent their time.

### SUMMARY OF THE INVENTION

According to another aspect of the present invention there is provided an activity recordal method comprising:
electronically monitoring for occurrence of events pertaining to one or more activities;
electronically associating information relating to said events with respective activities;
recording information relating to said events with data indicative of said respective activities in a database;
electronically generating reporting data from said information relating to said events recorded in said database; and
electronically outputting said reporting data.

In an embodiment, the information relating to the events comprises occurrence times of said respective events. For example, the activity of drafting a letter using a computer includes the commencement time of 9:00 am for opening the document and the completion time of 9:05 am for closing the document. In the embodiment, the method further comprises recording the occurrence times of the respective events with data indicative of the respective activities. It will be appreciated by those persons skilled in the art that the durations of time for the respective activities can be determined from the recorded occurrence times irrespective of their order of occurrence.

In an embodiment, the method further comprises populating a day by recording said occurrence times of said respective events occurring in the day with data indicative of said respective activities. That is, a user's day is populated with occurrence times of events pertaining to activities undertaken by the user and thus the user's day is populated with durations of times for the respective activities.

In an embodiment, the method further comprises associating said respective activities with matters and/or clients.

In an embodiment, the reporting data comprises at least one invoice comprising at least one of said respective activities with associated ones of said matters and/or clients. In another embodiment, the reporting data comprises a daily report for the user populated by activities performed in the day and the time taken to perform these activities, along with their corresponding matter and/or client details. It will be appreciated by those persons skilled in the art that the reporting data could include a report detailing activities performed by one or more users for a client, or for a particular matter, etc.

In an embodiment, the method further comprises electronically associating the respective activities with matters for respective clients via work slips associated with the matters recorded in the database, so that the clients can be billed for, or at least associated with, the respective activities. In this case, the work slips include matter details, such as a trade mark application, and respective client details, such as the trade mark applicant details, and the method electronically associates the respective activities with the matters via the work slips based on metadata contained in the recorded information relating to the events.

In an example, the metadata contained in the recorded information relating to the events comprises the matter details, such as a matter number or matter name, and/or the client details, so that the desired work slip can be identified for association of the respective activities therewith. In addition, the metadata may further include user details associated with a user performing the respective activities, such as user login details. The method may then further record the information relating to the events with data indicative of the respective activities on the work slips in the database.

In one example, the events occur on a user computer and thus the information relating to the events may include occurrence time, details of the computer hardware used to perform the event, document name, details of any programs used in relation to the document, etc. In addition, the information relating to the events may include metadata associated with the event (which may be contained in a document) including client details, such as a client phone number or email address associated with an event (e.g. an address header embedded in a word processor document) and matter details (e.g. a matter number embedded in a word processor document).

In another embodiment, the step of associating the respective activities to the matters via the work slips may be based on a previous association history of the corresponding events and activities to work slips. In an example, the step of associating the activities to the matters via the work slips may be performed manually by a user. In this case, the information relating to the events is reported and displayed to the user for a day, or any other period, so the user can associate the events and thus the respective activities, with the desired work slips based on a prior knowledge of the events or activities. In addition, the user may correct any incorrectly associated activities or events.

In an embodiment, the activity recordal method further comprises electronically generating reporting data comprising at least one invoice comprising at least one work slip. In the embodiment, the method further comprises electronically outputting the at least one invoice for the client. For example, the invoice includes at least one work slip thus the invoice may include details of the client, the activities performed by a user, the duration of time taken to perform these activities based on the corresponding occurrence times of events pertaining to these activities, and the corresponding charges to the client, such charges calculated by reference to the specific charging metadata contained within the slip. In the embodiment, at least one invoice is electronically outputted, generally, following request from the user.

In an example, client details may be recorded in the database and work slips may be subsequently created and recorded in association with matters containing these client details, whereby each work slip details the type of work undertaken by a user to complete one or more activities. The user may perform activities (e.g. opening and closing a word processor document to draft a trade mark application), and the corresponding events are monitored for occurrence times as well as other information described above. The corresponding occurrence times (part of the information relating to the events) are subsequently associated with the respective activity, such as opening a word document at 10:00 am and editing the document before closing it at 10:30 am for a trade mark application. This information is then associated with the matter “trade mark application” via the corresponding work slip. The corresponding occurrence times and data indicative of the respective activities are recorded in the database on the respective work slips so that the activities can be billed to the clients and the narrative for the invoice can be derived from the activity and matter details. In the above example, the client may be invoiced for 0.5 of an hour at the user's predefined rate for services rendered in drafting the trade mark application. However, in an alternative example, the client may be billed based on the type of activity performed or document type edited, e.g. drafting a trade mark application may be charged at a different rate to drafting a patent application. It will also be appreciated by those persons skilled in the art that other billing methods may be deployed such as applying a billing formula to events pertaining to activities based on the recorded event information.

In an embodiment, the activity recordal method further comprises electronically generating reporting data in a form of at least one report comprising at least one work slip. It is to be appreciated by those persons skilled in the art that a user may perform events pertaining to both billable and non-billable activities and the activity recordal method may be used to record both these billable activities, such as drafting a trade mark application for a client, and non-billable activities, such as performing marketing duties.

In an example, the method may electronically generate reports including business analytical type reports. These reports may be used in such situations of assisting in making more accurate decisions relating to such matters as human resourcing (e.g. understanding the actual utilisation rates of personnel), business planning and development (e.g. being able to measure real levels of profit associated with different service lines by reference to charged amounts and time actually taken), and more accurate predictive costings and quotes (e.g. being able to offer fixed fee or not to exceed fee quotes).

As described, the method includes electronically monitoring for occurrence times of the events occurring in a day and populating the day by recording the corresponding occurrence times of the events occurring in the day with data indicative of the respective activities. In this case, it will be appreciated by those persons skilled in the art that all events performed by a user in a day, for both billable and non-billable activities, may be recorded and thus the user's day may be populated by recording the corresponding occurrence times of all the events occurring in the day with data indicative of respective activities. In this way, the user's activities for the day may be recorded in an accurate fashion and may, in one embodiment of the present invention, be reviewed as a Gantt chart of corresponding occurrence times of events pertaining to activities. In the embodiment, the user may amend any associations of events with activities, or work slips, recorded in the database but may not edit the corresponding event information to ensure accuracy of the recordal method. In this way, information relating to all the activities performed by a user in a day is recorded and the user may subsequently “sculpt down” this record by verifying associated activities and associating unassociated (or unallocated) activities to matters on work slips as described above.

According to another aspect of the present invention there is provided an activity recordal system comprising:
a plurality of monitoring modules adapted to monitor for occurrence of events pertaining to one or more activities;
an associating module adapted to associate information relating to said events with respective activities;
a recording module adapted to record said information relating to said events with data indicative of said respective activities in a database;
a generating module adapted to generate reporting data from said information relating to said events recorded in said database; and
an outputting module adapted to output said reporting data.

In an embodiment, the database is located on a server connected to a network. It will be appreciated by those persons skilled in the art that the network may be the Internet, Local Area Network (LAN), or a Wide Area Network (WAN).

In an embodiment, at least one of the monitoring modules is adapted to monitor for occurrence of events on a user computer connected to the network. It will be appreciated by those persons skilled in the art that the user computer includes those devices with a processor, such as a mobile device, PDA, etc. In another embodiment, at least one of the modules may be adapted to monitor for occurrence of events occurring on facsimiles, phones, phone lines, industrial machines (such as those in a manufacturing production line), etc. Therefore, it will be appreciated by those skilled persons that the monitoring modules may be deployed on any device, transmission line, machine, etc, that requires monitoring for occurrence of events occurring thereon.

In an embodiment, the monitoring modules are arranged to communicate information relating to the events to the database on the server over the network for subsequent association and recordal.

In an embodiment, the user computer may have a application resident thereon, such as a plug-in application, comprising the at least one monitoring module. In another embodiment, the application receives and forwards the information relating to the event from one or more of the monitoring modules either residing therein, or in data communication there therewith, to the server over the network. In the embodiment, the application may also receive and forward metadata associated with the events from each monitoring module over the network to the server. Also, the application may be adapted to forward the information relating to the events upon occurrence or at configurable time intervals to the server to reduce bandwidth requirements.

In an embodiment, the application may be adapted to communicate with a dedicated instance of the database pertaining to an individual user on the server. That is, each user of the time recordal system may have a dedicated instance of the database on the server which can be recorded to and is accessible over the network. In an example, each user of the system has a user computer with an application resident thereon to communicate with the dedicated instance of the database over the network.

In an embodiment, the plug-in application comprises the associating module to associate information relating to the events upon occurrence with respective activities and then forwards the information relating to the event in association with the respective activities to the server over the network. In another embodiment, the associating module operates on the server and in this embodiment the plug-in application forwards the information relating to the events to the associating module on the server. In another embodiment, the associating, recording, generating and outputting modules operate on the server.

In an example, each third party application running on the user computer, e.g. Word, Excel, etc, has a monitoring module associated therewith that monitors its usage and communicates event related information (including metadata and event occurrence times), via a plug-in application resident on the user's computer. In addition, monitoring modules may monitor for occurrence of events occurring on devices peripheral to the user computer having administrating software running on the computer, such as an electronic Dictaphone or a VoIP phone. In another example, the monitoring module may be an operating system event logger which logs all events from programs running on the user's computer in association with usage information. Such usage information may include details such as filename, event duration, and metadata associated with the events, including embedded email addresses, phone numbers, etc, as described above.

In another embodiment, at least one of the monitoring modules is adapted to monitor for the occurrence of events on the server itself to monitor time spent by users accessing the server. For example, the user may wish to amend the association of recorded activities to work slips and the duration of time spent doing this can be derived from the information captured by the monitoring module for this activity. In addition, at least one of the monitoring modules may be adapted to monitor for the commencement and completion of events on a PABX exchange in data communication with the server to monitor occurrence of phone call events.

According to another aspect of the present invention there is provided computer program code usable to configure a server to implement an activity recordal method, the server being configured to:
receive information relating to events pertaining to one or more activities from at least one monitoring module over a network adapted to monitor for occurrence of said events;
associate said information relating to said events with respective activities;
record said information relating to said events with data indicative of said respective activities in a database located on the server;
generate reporting data from said information relating to said events recorded in said database; and
output said reporting data.

According to another aspect of the present invention there is provided computer program code usable to configure a user computer to implement an activity recordal method, the user computer being configured to:
receive information relating to events pertaining to one or more activities from at least one monitoring module adapted to monitor for occurrence of said events;
associate said information relating to said events with respective activities;
record said information relating to said events with data indicative of said respective activities in a database;
generate reporting data from said information relating to said events recorded in said database; and
output said reporting data.

According to another aspect of the present invention there is provided a computer program code which when executed implements the above method.

According to another aspect of the present invention there is provided a computer readable medium comprising the above program code.

According to another aspect of the present invention there is provided a data signal comprising the above program code.

### BRIEF DESCRIPTION OF THE DRAWINGS

In order that the invention be more clearly ascertained, embodiments will now be described, by way of example, with reference to the accompanying drawings, in which:

FIG. 1 is a schematic view of an activity recordal system according to an embodiment of the present invention;

FIG. 2 is a schematic view of the system of FIG. 1;

FIG. 3 is a flow chart of the method implemented by the system of FIG. 1 according to an embodiment the present invention;

FIG. 4 is a further flow chart of the method of FIG. 3;

FIG. 5 is a screen shot of a display generated by an embodiment of the present invention;

FIG. 6 is a screen shot of a display generated by an embodiment of the present invention;

FIG. 7 is a screen shot of a display generated by an embodiment of the present invention;

FIG. 8 is a screen shot of a display generated by an embodiment of the present invention;

FIG. 9 is a screen shot of a display generated by an embodiment of the present invention;

FIG. 10 is a screen shot of a display generated by an embodiment of the present invention;

FIG. 11 is a screen shot of a display generated by an embodiment of the present invention;

FIG. 12 is a screen shot of a display generated by an embodiment of the present invention; and

FIG. 13 is a screen shot of a display generated by an embodiment of the present invention.

### DETAILED DESCRIPTION

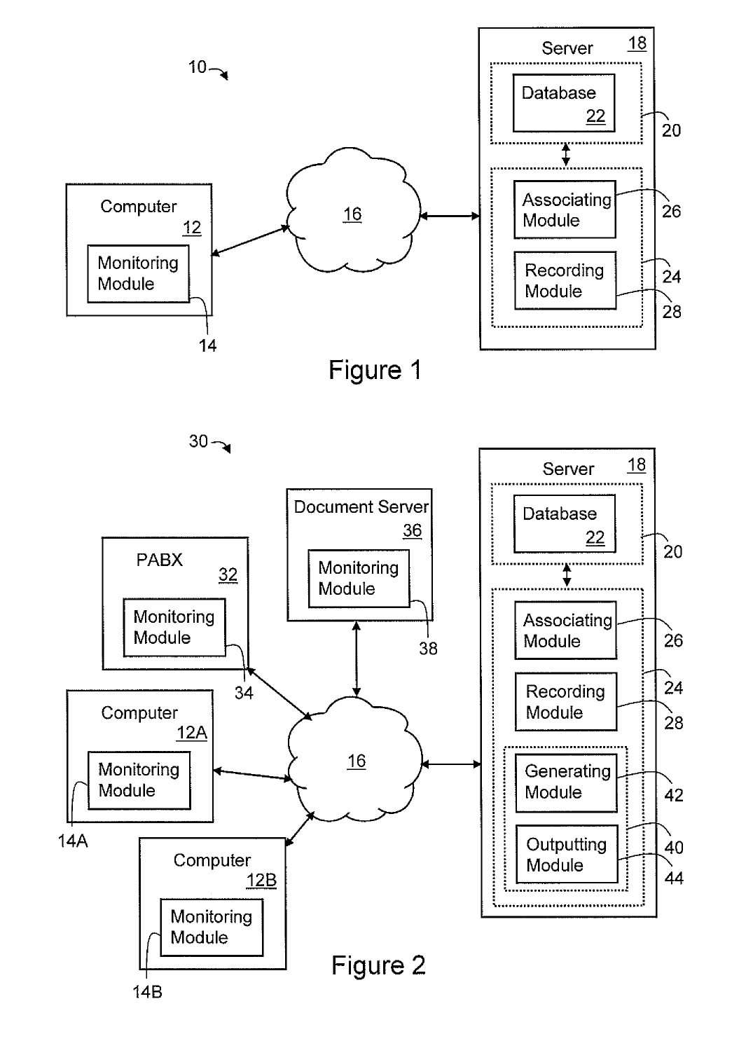

According to an embodiment of the present invention, there is provided an activity recordal system 10 including a user computer 12 having a monitoring module 14 adapted to monitor for the occurrence of events pertaining to one or more activities occurring on, or associated with, the user computer 12, as shown in FIG. 1 The user computer 12 then transmits information relating to the events and the activities upon occurrence of the events over the network 16 to a server 18. The user computer 12 may transmit the information immediately upon occurrence of the events or at configurable time intervals. In the embodiment, the server 18 includes a memory 20, storing a database 22 thereon, and a processor 24, including a number of modules adapted to implement the system as described. The processor 24 may include an associating module 26 to associate the information relating to the events with respective activities and a recording module 28 to record the information with data indicative of the respective activities in the database 22. The database 22 thus has a record of all events pertaining to activities occurring on the user computer 12. As described the information includes the respective occurrence times of these events and thus the durations of the respective activities can be determined. It will be appreciated by those persons skilled in the art that the activities may be designated by the system 10 and include both billable and non-billable work-related activities, such as filing a trade mark application and drafting a marketing document.

For example, a user of the computer 12 may open a word processor document entitled “patent application” at 9:00 am. This event is then logged by the monitoring module 14 and the commencement time, date, and corresponding usage information, such as the file name “patent application.doc”, is sent to the server 18 by a plug-in application resident on the user computer 12 for subsequent associating and recording. The plug-in application may also provided the user interface for the user or may employ an existing interface, such as a web browser, to enable the user to interact with the system 10. It will be appreciated by those skilled in the art that the application resident on the computer includes the monitoring module 14 and may also include the associating module 26 and/or the recording module 28 to communicate and/or record information to and from the database 22. In an alternative embodiment, the database may be resident in the user computer 12 memory and the application may contain the associating module 26 and the recording module 28 to communicate with the local database.

In the example, if the user opens a further word processor document on the user computer 12 entitled “trade mark application” at 9:30 am and either closes the “patent application” document or leaves it open in the background, the monitoring module 14 will detect this and send an event occurrence time of 9:30 am, and date, to the server 18 for the “patent application” document and an event occurrence time of 9:30 am for the “trade mark application” document, i.e. the monitoring module 14 monitors for the event occurring in the foreground of the user computer 12. The monitoring module 14 is thus able to discern events occurring in both the foreground and the background to determine which activity is in “focus” and being performed by the user. The associating module 26 may then associate the corresponding information, including the occurrence times, with the activity of editing the word processor document entitled “patent application” and the recording module 28 then records this information with data indicative of editing the word processor document, such as the file name, in the database 22. It is also envisaged that a completion time of the event may also be sent to the server 18 if there is determined a period of inactivity on the computer 12 and confirmed by the user's actual positive acceptance of this fact or deemed to have been confirmed by a failure of the user to so confirm.

In addition, the monitoring module 14 monitors for inactivity and, in the event that a user is inactive at their workstation, the computer 12, for a configurable period of time, an idle-timer is automatically triggered. This idle-time trigger is configurable on a per-user basis and can be changed at anytime based on the user's individual preference. In addition, it is envisaged that a fail-safe is introduced to ensure that the timer continues in the situation that the computer 12 receives accidental input, for example, through a vibration (e.g. folders being dropped onto the desk, or heavy footsteps passing by) causing the mouse to move, or an accidental bump of the computer's keyboard.

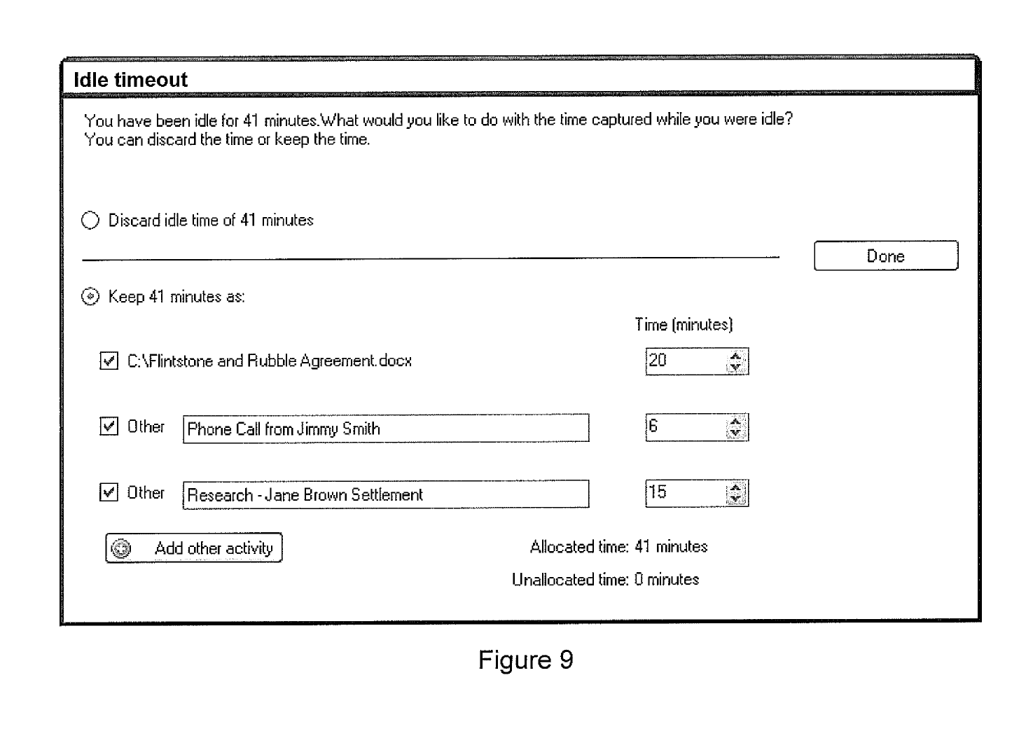

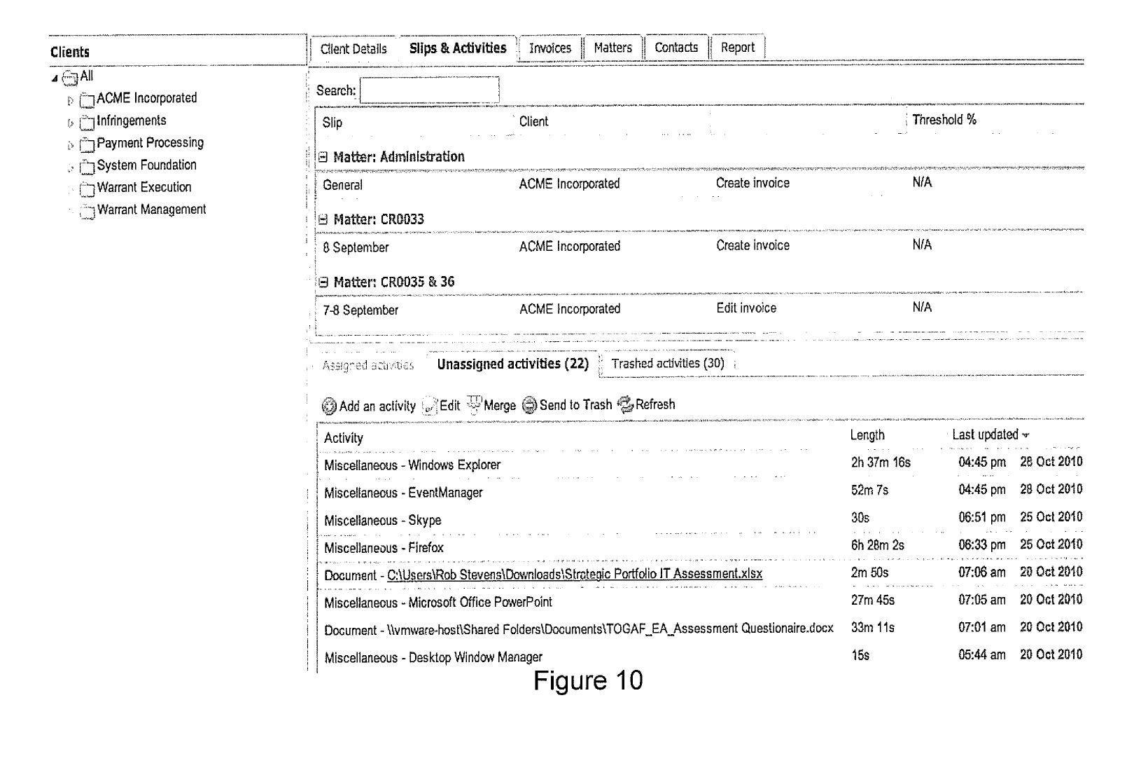

Upon returning to the computer 12 and thereby automatically triggering the idle-time out feature, a new pop-up screen emerges on the user interface, as shown in FIG. 9, requiring the user to associate the time that has been spent whilst the user was away from the computer 12. That is, the time spent away from the computer 12 becomes an unknown activity that can either be identified by the user or discarded by either a) declaring that they do not wish to allocate the time to any particular matter, project or file and consequently send the idle time captured to “Trash” or b) create one or multiple entries describing the time which is then captured and recorded as individual activities in an unassigned activity queue shown in FIG. 10. Each individual activity can be allocated a customisable portion of the total idle-time recorded (but the total time cannot be greater than the actual time spent away from the workstation, thus preserving the integrity and accuracy of automatic time capture).

In addition, in the situation where the user has been working at their computer 12 while perhaps reading an open document that has not required input, and the idle-timer has engaged, upon triggering the Idle Time-Out function with a form of user input, the Idle Time-Out function recognises which application run by the computer 12 is in focus and offers to allocate the idle time to the current application by default. For example, the user interface provided the option to the user to accept the offered application with one-click of the mouse so that the user can continue work with minimal disruption. If the user is attending to something other than the default application recognised by the idle time out function (e.g. an offline task such as a conversation or meeting) then, again, the idle time out feature enables the user to create one or multiple entries describing the time they have been idle from their workstation which are then captured and recorded as individual activities in the unassigned activity queue. Each individual activity can, again, be allocated a customisable portion of the total idle-time recorded (but the total time cannot be greater than the actual time spent away from the computer 12, thus preserving the integrity and accuracy of automatic time capture).

In addition to requesting completion of the idle time description, the application residing on the computer 12 also has the capability to inspect a user's current calendar or schedule (e.g. in Outlook) to identify if there are any meetings or appointments that correspond with the ‘idle time’ and seeks confirmation from the user so as to auto-populate the idle time with the relevant event(s) from the user's calendar or schedule.

As described, when the monitoring module 14 determines occurrence of events pertaining to activities from the user's computer 12, information, such as occurrence time and metadata, relating to the events, is associated with the respective activities and captured on the database 22. However, not all of these raw activities captured from the user's computer 12 can be electronically associated to matters based on metadata contained in the recorded information. In this case, the user interface present these activities in the unassigned queue shown in FIG. 10 in a chronological order by reference to the event type, for example whether the event was an email, meeting, document drafting, telephone call or other. Together with a reference to the activity type, the activity descriptor also contains some raw descriptive data (for example the title of the document or the title of the email) together with the time associated with the performance of that activity.

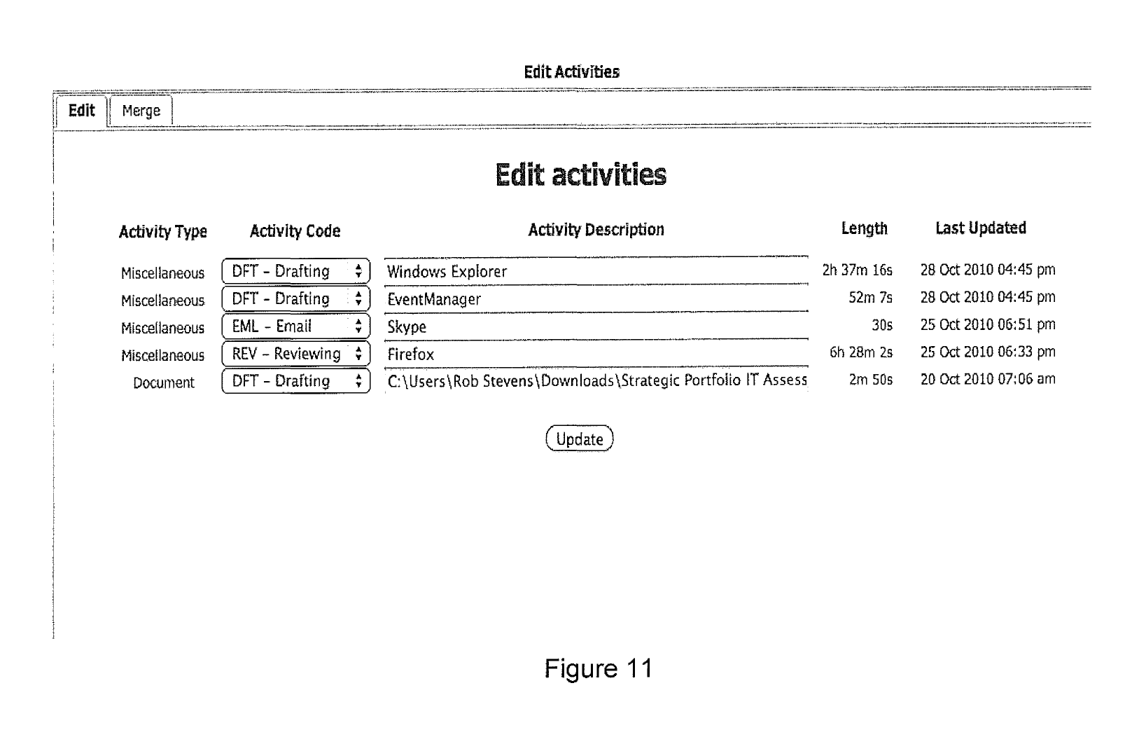

The description of these activities can also be edited to meet the user's particular requirements for the purpose of presenting the activity in a report (such as an invoice), as shown in FIG. 11.

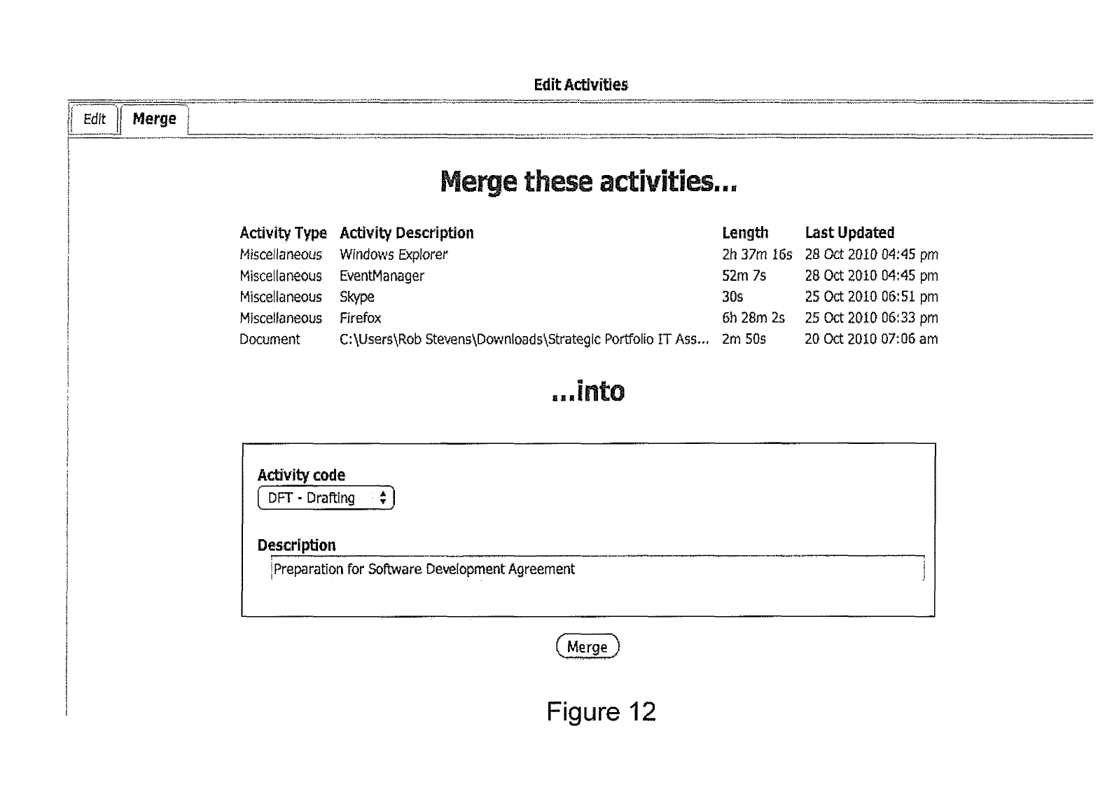

Users of the user interface can select any number of related activities from the unassigned queue for the purpose of consolidating those activities into one defined activity. That is, it is recognised that multiple activities may be associated with the one work task or matter. For example, a particular assignment may be comprised of a telephone call, some web research, drafting a document and a short meeting. Rather than appearing on a report or invoice as individual items, they can be merged and re-described as a particular task, sub-project or matter. They will then appear in a report at activity level, as one line item, however the individual activities themselves are preserved for reporting and analysis purposes. At the point of merging these activities the system 10 consolidates all of the time associated with the underlying selected activities and allows the user to draft an amended description for the consolidated event, as shown in FIG. 12.

Also, to associate (or allocate) activity to a client or matter, one or multiple activities are selected from the Activities Queue shown in FIG. 10 and simply dragged across to the appropriate Client and Matter (or Project/Sub-project) and then released.

FIG. 2 shows an embodiment of an activity recordal system 30 having a number of components connected to the network 16 for monitoring. The system 30 includes a PABX exchange 32 with a corresponding monitoring module 34 for monitoring user telephone calls and a document server 36 with a corresponding monitoring module 38 for monitoring retrieval of documents from the document server 36. In addition, it is shown that the system 30 further includes a number of user computers 12A & 12B connected to the network 16, each having corresponding monitoring modules 14A & 14B to monitor for corresponding events occurring on the user computers. Also, the embodiment shown in FIG. 2 is exemplary of a firm environment (such as a law firm) where a number of users' activities are recorded for billing or invoicing corresponding clients for billable activities performed and business intelligence gathering. It is to be appreciated by those persons skilled in the art that such a firm environment may also encompass an environment where the users may be geographically remote from each other and components of the system 30 may communicate via the Internet 16.

In the embodiment, the system 30 enables the complete recording of the user's day by the parallel capturing of events from multiple sources, such as the document server 36, PABX 32, computer 12A, mobile telephone (not shown), PDA (not shown), etc. In this case, the associating module 26 and recording module 28 associate and record information relating to events with data indicative of activities in the database 22 based on the user's login details. That is, the recording module 28 records events occurring on, for example, a desktop computer, a laptop, a smartphone and any portable device that may be used for productive tasks where the user is required to login. If the device being used by the user is not be connected to the network 16 (the medium that allows the events to be transmitted to the central server 18), the device caches the events, indefinitely until the connection is established allowing them to be transmitted accordingly.

In order to generate reports for gathering business intelligence or billing corresponding clients, the processor 26 shown in FIG. 2 may further include an accounting package 40 to generate and output reporting data to a user. The accounting package 40 includes a generating module 42 for generating reporting data, which may be in the form of a report (e.g. an invoice) from the information relating to the events recorded in the database 22, and an outputting module 44 for outputting the report. In addition, the system 30 may further associate the respective activities to clients via work slips recorded in the database 22 comprising client details and matter details so that the respective billable activities can be more readily associated with respective matters and clients.

In the embodiment shown in FIG. 2, the associating module 26 receives usage information over the network 16 from the respective monitoring modules 14A, 14B, 34, & 38 including occurrence time of events pertaining to activities and associated metadata. As described, the usage information includes metadata associated with the corresponding events including client details, such as an email address. Using the above example, the document “patent application” may be opened, edited and subsequently closed by a user. As described, the document may contain metadata, such as the client's email address (a@XYZ.com) and a matter number (P12345.AU) within the document, and this may be used by the associating module 26 to associate the activity of editing the “patent application” document to the matter of a patent application for the client XYZ Pty Ltd via the work slip containing this information. It will be appreciated that the processor 24 may contain a module adapted to look up and compare stored client information.

The client details may also be manually entered into the database 22 however it is envisaged that the client details retrieved from metadata from the respective monitoring modules 14A, 14B, 34, & 38 may be used to automatically record client details to the database 22 using the recording module 28. Similarly, work slips may be manually created by users and recorded by the recording module 28 into the database 22, or be automatically generated based on suitable metadata such as a subject field of an email entitled “trade mark application for client ABC Pty Ltd”. In an example, the work slip is manually entered and relates to the matter, or type of work undertaken by a user, and the respective client (e.g. patent application for client XYZ Pty Ltd). The activity of editing the document entitled “patent application” is subsequently associated with information relating to the events of opening and closing the document “patent application” (e.g. 9:00 am and 9:30 am respectively). Thus, the activity recordal system can be used to generate and output an invoice using the accounting package 40 for the client (e.g. XYZ Pty Ltd) for services rendered in relation to the “patent application”.

As described, the user computer 12 comprises an application resident thereon to enable a user to interact with the activity recordal system 30. In addition, the application implements a user interface configured to input/output data to the user irrespective of the underlying accounting package 40 or other IT system such as the firm's practice management or financial accounting systems. That is, the user interface presents a consistent look and feel to users of the activity recordal system 30 even when different underlying accounting packages 40 are used.

The activity recordal system 30 is synchronised, or configured to be used, with the underlying accounting packages 40, such as source Project, Finance or Practice Management solutions, as follows. For each individual user, the appropriate Clients and Matters, stored with respective to the accounting package 40, are updated within the system 30 via the application programming interface (API). This is constantly monitored with updates occurring in real-time during an operational day. That is, the moment a new Client, Matter or Project is created in the accounting package 40, it is available for work allocation in the system 30. Further, during the working day the user is able to allocate their productive events to the appropriate Client, Matter or Project via the user interface as described, and at the close of business, or at a time determined appropriate within the production environment, these events are uploaded to the accounting package 40 by mapping of each client, matter and project.

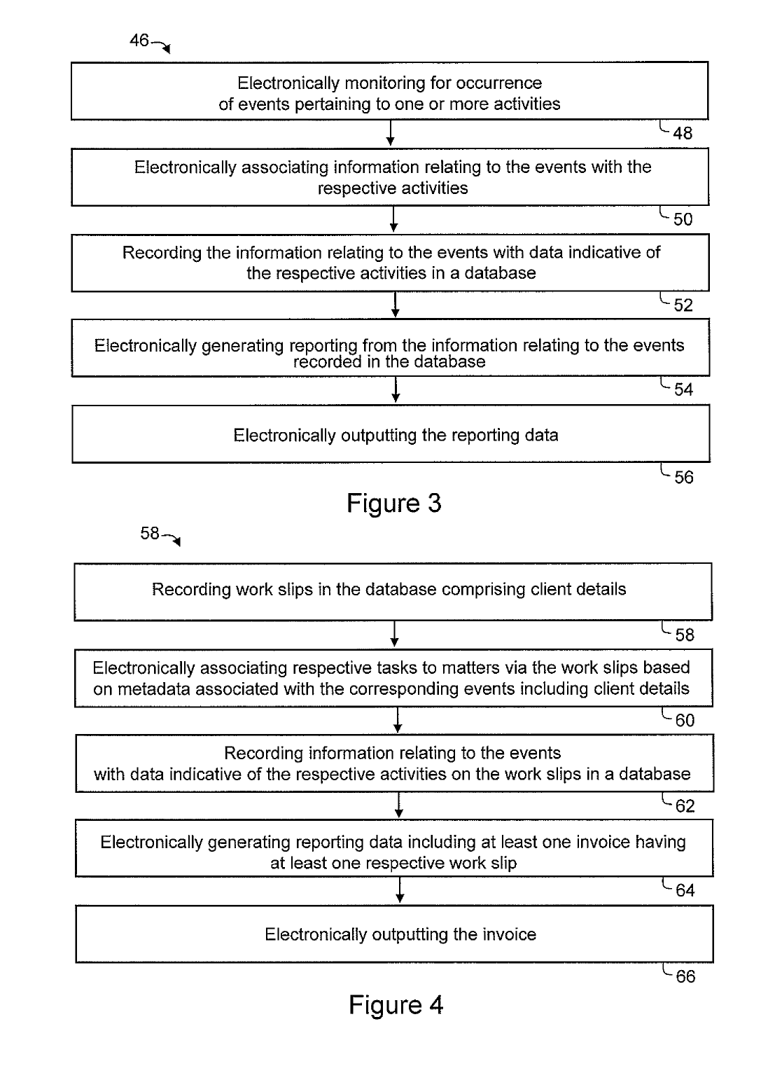

FIG. 3 illustrates a flow chart of the method 46 implemented by the above described activity recordal system. The method 46 includes electronically monitoring 48 for occurrence of events pertaining to one or more activities and electronically associating 50 information relating to the events with the respective activities. As described, the information relating to the events includes occurrence times so the duration of time the user spent on the respective activities can be determined. The method 46 further includes recording 52 the information relating to the events with data indicative of the respective activities and this recordal of information enables the user's day to be automatically populated in real time with corresponding times for performed activities. Thus, the user's day is accurately recorded and can be reviewed for billing or other data collection purposes. In addition, the method 46 includes electronically generating 54 reporting data from the corresponding commencement and completion times recorded in the database and electronically outputting 56 the reporting data.

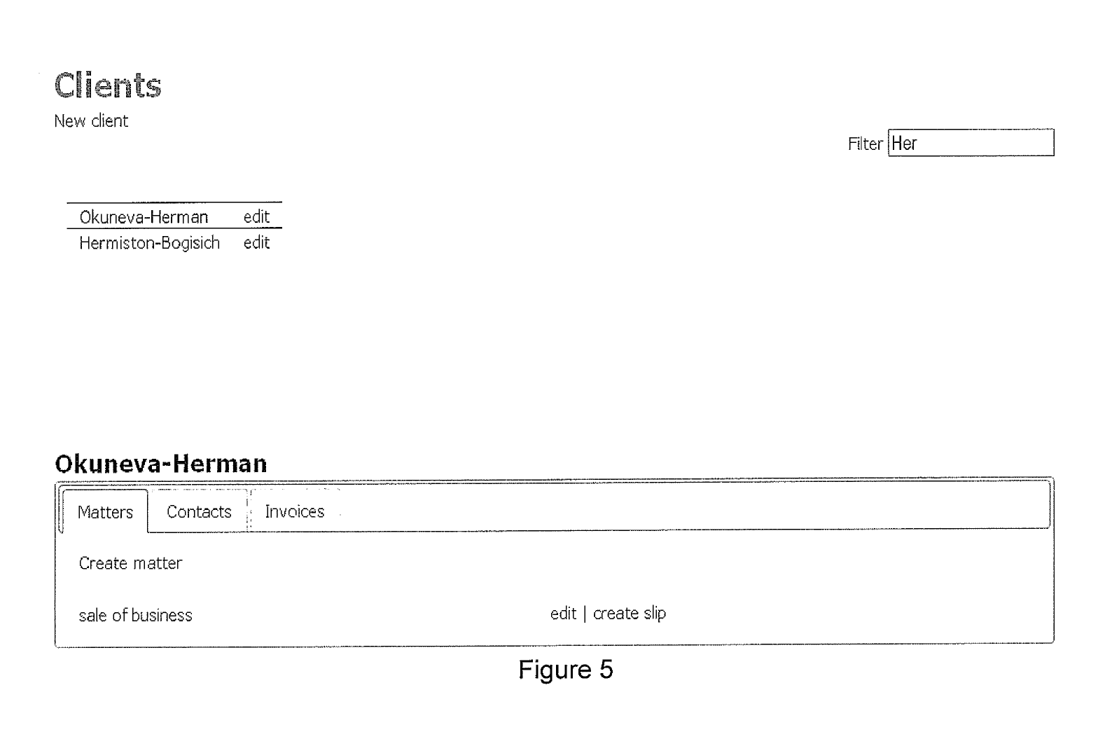

FIG. 4 illustrates a flow chart of the method 58 implemented by the above described activity recordal system showing the billing procedure in further detail. The method 58 includes recording 60 work slips in the database comprising matter and client details, electronically associating 62 respective activities to matters for respective clients via the work slips. The association being based on metadata contained in information relating to the events and the method 58 further includes recording 64 the information relating to the events with data indicative of the respective activities on the work slips in a database. As described, the work slips and client details may be manually entered into the database and the step of associating respective activities to matters via the work slips may be automatically performed by the method based on the metadata. However, in the case where the metadata does not contain client information, or information relating to a matter, or a work slip previously associated thereto, the user may view the day populated with the corresponding activities and manually associate at least some of those to work slips. Also, it will be appreciated by those skilled in the art that, in the case where the task is non-billable, the client may be the user's employer and the work slip may contain the employer's details.

The method 58 further includes electronically generating 66 reporting data including at least one invoice having at least one respective work slip. As described, the work slip denotes the activities performed by the user for a matter and the client's details. Thus, the invoice will be addressed to the client and have a narrative including details of the activities performed and the duration of time taken to complete these activities derived from the occurrence time of the events pertaining to the activities. Further information may also be presented to the client in the invoice, if required, such as the dates the activities were performed. In addition, the method 58 includes electronically outputting 68 the invoice, e.g. printing the invoice. As described, generally the user will request the invoice from the activity recordal system when the activities are performed however it is envisaged that some invoices may be automatically generated, such as those generated periodically.

FIGS. 5 to 8 illustrate screen shots exemplifying the activity recordal method described above. FIG. 5 shows a user initially creating a new client in the database by entering the client's details, e.g. “Okeneva-Herman”, and then creating a new matter associated with that client, e.g. “sale of business”. In addition, the user may then create a work slip associated with the matter so that activities performed by the user associated with the sale of the business can be associated with the matter and invoiced to the client.

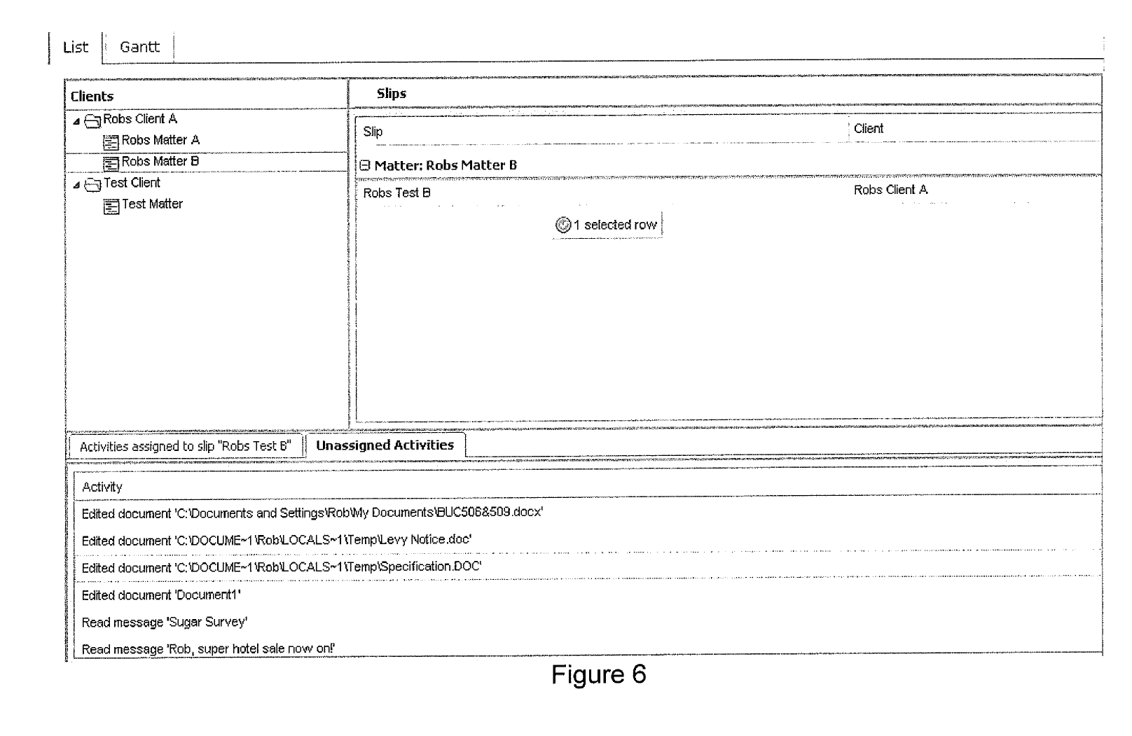

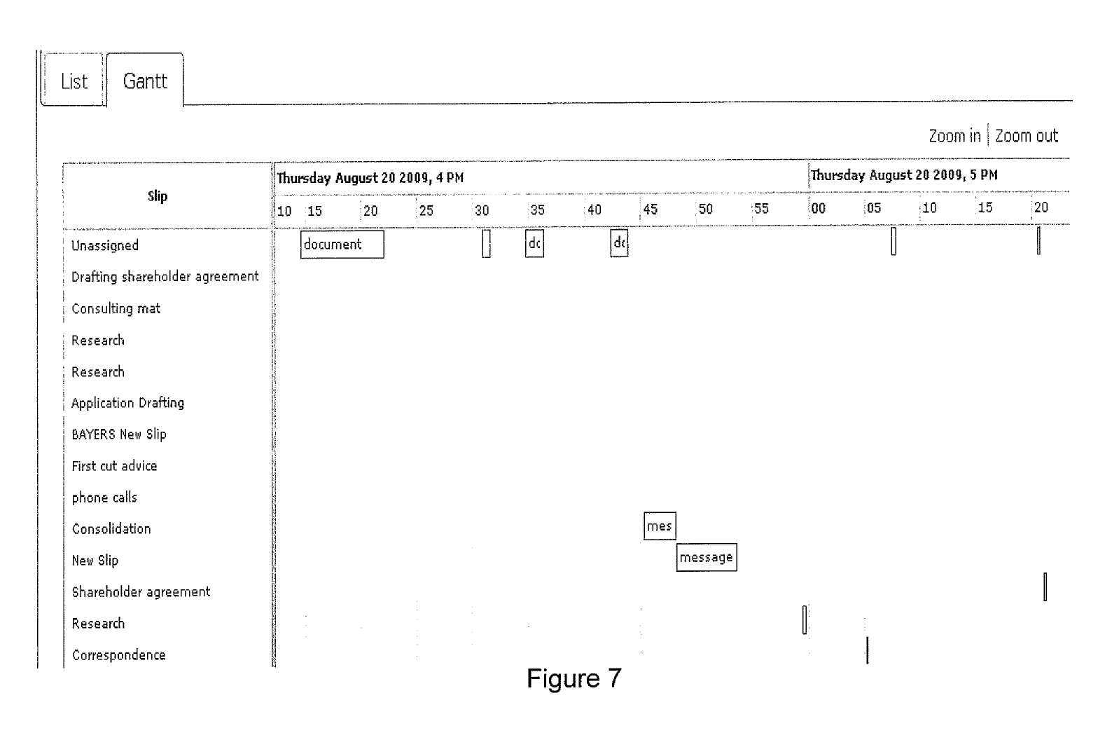

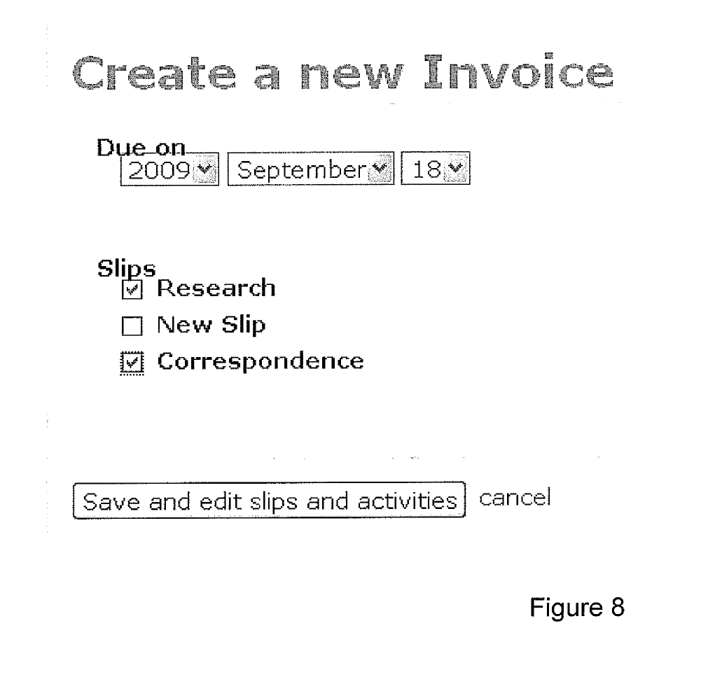

FIG. 6 illustrates a screen shot of an activities manager interface for the database showing a list of open work slips, i.e. work slips for matters not billed and subsequently closed. In addition, the activities manager interface shows activities as a sequence of events which have corresponding occurrence times (not shown). Some of the activities are shown as assigned, i.e. associated, to the corresponding matter “Robs Matter B” and to the open work slip “Robs Test B”. However, some activities could not be associated based on metadata to a work slip and are thus listed for the user to subsequently associate. This subsequent user association may be done by viewing the unassigned activities in either a list form, as shown in FIG. 6, or a Gantt chart form, as shown in FIG. 7. Using the Gantt chart, the user can view information relating to the events pertaining to the activities performed for a desired day(s)—Thursday Aug. 20, 2009—and associate any unassigned activities to work slips so that they can be allocated to a respective client's matter. This billing procedure can be seen in FIG. 8 where the user selects to create an invoice for a client to bill them for the activities carried out in relation to the work slips “Research” and “Correspondence”.

A further example of activity recordal is detailed below with reference to FIG. 1.

The system 10 for activity recordal includes a set of software modules for performing monitoring functions (e.g. monitoring module 14) including program logic to discriminate as to relevant activity, and transmitting monitoring data over the Internet 16, a relational database 22 held on a secure remote server 18 to hold both the captured monitoring data and the other relevant information referred to above, business logic controlling the relational database 22 to implement the program logic referred to above, and a web browser based user interface for accessing and operating the database on a user computer 12.

The system uses the monitoring modules to capture as many activities as possible and records them in a real-time journaling application (e.g. a populated day of activities) by grouping and allocating events to work slips in a semi-automated allocation system (e.g. by associating activities to matters for respective clients via work slips as described above). In the system, the activities not associated are dealt with manually at the end of the day or other specified time period.

The software modules for monitoring may be implemented as plugins for various Microsoft applications (e.g. Outlook, Word, Excel and Internet Explorer 8) and a master collection Windows Service component for use inside an operating system such as Windows XP, Vista and 7. However, it is envisaged that the monitoring modules could equally be implemented in other applications, other operating systems (e.g. Mac OS X, Linux) and even for other hardware (e.g. digital voice dictation units and VoIP PBXs). The modules can also readily be devised for monitoring of emergent applications, platforms and operating systems, such as activities on Google Docs, Google Wave, and other collaborative tools. Whatever hardware, software or combination thereof the modules are written for or working in, their basic function is to detect in real time relevant events inside the monitored hardware/software (e.g. booting up, logging in, logging out, opening a document, editing a document, closing a document, and so on) going towards describing or referencing activities. In any event, the modules are set up to see which user is using the monitored hardware (e.g. a PC) and when, what applications are opened, and what applications are actively being used via a ‘focus system’ to review which application the user is currently working in.

Referring back to FIG. 1, the captured event information regarding activities is sent from the user computer 12 to the remote server 18 hosting the database 22 where it is received and, to the extent possible based on existing data stored in the system, associated (or allocated) to a client and a matter by allocating and grouping events pertaining to activities on work slips. The slips being the aggregations of copies of activity entries from an underlying journal of a user's day populated by the respective activities. Following initial auto allocation, the user then has the ability to associate unallocated activities; the association being only symbolic in that the underlying event data is not altered.

The user can also interact with the work slips and the other relevant information via the web interface and this allows for “sculpting” of available time out of a day (or other chosen/specified time period) of activities by finalising the association of activities as referred to above. It also allows for entry and editing of other relevant information. Slips with associated activities can be tailored to a variety of functions including the preparation of billing narratives by finalising and ‘locking down’ the slips to be billed. However, the work slips could equally be restructured to allow for reporting and business analytics functions.

Indeed, the quality and extent of event data presently being collected for inclusion in billing narratives means that invoices generated from the system have existing potential to serve highly valuable business analytical functions.

In an example demonstrating that event-tracking captures and measures the productivity of a user in greater detail and accuracy, the user of the activity recordal system 10 has the following usage statistics (which are indicative of the level of detail and accuracy captured via the activity recordal system 10):
The average capture of day for the user: 99.5%
The average individual events per day: 532
(i.e. not activities as presented in the user interface, but individual events that make up these activities)
The average day length: 9.06 hours/day
The average total hours captured: 9.01 hours/day
The average billable work hours captured and allocated to a client/project: 5.90 hours/day
The average trashed hours: 3.10 hours/day

Thus, in this example, the average day length is 9.06 hours and the estimated billable work time is 9.06 hours (whole day) minus 3.10 hours (trashed), which equates to 5.96 billable hours. In addition, the user in this example switches focus between applications on the user computer 12 on average 135.11 times per day thus demonstrating the operational limitation and inherent inaccuracy of ‘stop-watch’ methods focusing on only one activity at a time. The system 10 thus is a real-time event tracking system that monitors the user's activities and their work patterns for all the time they are using the user computer 12 (e.g. logged onto their workstation or otherwise online, for example via a mobile device such as an iPhone or Blackberry).

The software residing on the user computer 12 thus captures and records information in the form of detailed workflow data, such as individual software applications and their utilisation, the amount of time spent in meetings versus the amount of time scheduled for meetings, efficiency when performing particular sub-projects or matter types. In addition, this data can be further processed for analysis. For example, the data can be used to derive workflow patterns that are most effective when performing particular matter types, and analyse and report on Budgeted Work versus Actual Work completed.

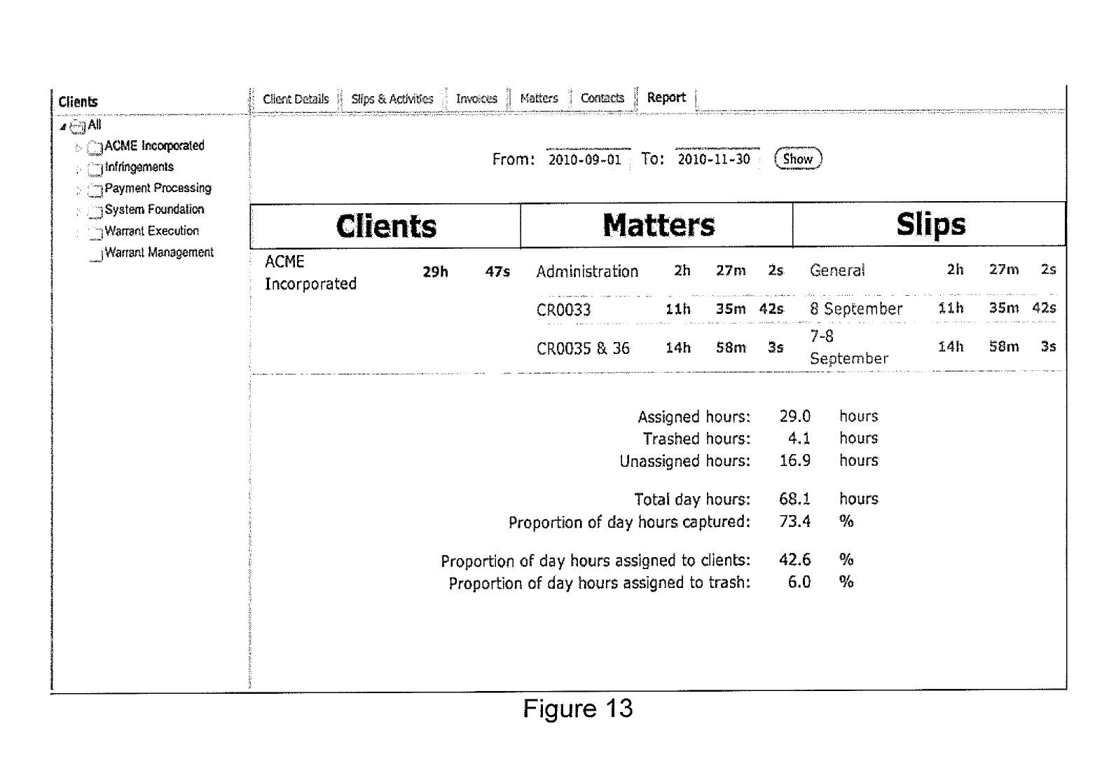

FIG. 13 shows a report outputted to the user via the computer 12 detailing usage statistics and the time associated with respective activities for a client. In particular, FIG. 13 shows a report tab selected and a desired date range inputted for viewing associations for a particular client selected based on inputted calendar dates. It can be seen from the report how much time has been allocated to each client, matter and the work slip associated with the Matter. Also, some summary statistics are also provided to demonstrate the productivity, and utilisation of the user, during the specified timeframe.

It will be understood to persons skilled in the art of the invention that many modifications may be made without departing from the spirit and scope of the invention.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art is referred to herein, such reference does not constitute an admission that the prior art forms a part of the common general knowledge in the art in any country.

1. An activity recordal method comprising:
electronically monitoring for occurrence of events pertaining to one or more activities;
electronically associating information relating to said events with respective activities, the information comprising occurrence times of said respective events;
recording said information relating to said events with data indicative of said respective activities in a database;
electronically generating reporting data from said information relating to said events recorded in said database; and
electronically outputting said reporting data.

2. (canceled)

3. An activity recordal method as claimed in claim 1, further comprising recording said occurrence times of said respective events with data indicative of said respective activities.

4. An activity recordal method as claimed in claim 1, further comprising populating a day or other work period by recording said occurrence times of said respective events occurring in the day or other work period with data indicative of said respective activities.

5. An activity recordal method as claimed in claim 1, further comprising associating said respective activities with matters and/or clients.

6. An activity recordal method as claimed in claim 5, wherein said reporting data comprises at least one invoice comprising at least one of said respective activities with associated ones of said matters and/or clients.

7. An activity recordal method as claimed in claim 1, further comprising electronically associating said respective activities with matters for clients via work slips associated with said matters recorded in said database, each of said work slips comprising respective matter details and corresponding client details.

8. (canceled)

9. An activity recordal method as claimed in claim 7, further comprising electronically associating said respective activities with said matters via said work slips based on metadata contained in said recorded information relating to the events.

10. (canceled)

11. An activity recordal method as claimed in claim 7, wherein said reporting data comprises at least one invoice comprising at least one said work slip.

12. (canceled)

13. An activity recordal system comprising:
a plurality of monitoring modules adapted to monitor for occurrence of events pertaining to one or more activities;
an associating module adapted to associate information relating to said events with respective activities, said information comprising occurrence times of said respective events;
a recording module adapted to record said information relating to said events with data indicative of said respective activities in a database;
a generating module adapted to generate reporting data from said information relating to said events recorded in said database; and
an outputting module adapted to output said reporting data.

14. An activity recordal system as claimed in claim 13, wherein the database is located on a server connected to a network.

15. An activity recordal system as claimed in claim 13, wherein at least one of said monitoring modules is adapted to monitor for occurrence of events on a user computer connected to a network.

16. An activity recordal system as claimed in claim 15, further comprising an application resident on the user computer comprising the at least one of said monitoring modules.

17. An activity recordal system as claimed in claim 15, wherein the database receives said information relating to said events over the network from the user computer either upon occurrence or at configurable time intervals.

18. (canceled)

19. An activity recordal system as claimed in claim 16, wherein the application is adapted to communicate with a dedicated instance of the database on the server pertaining to a user of the user computer.

20. An activity recordal system as claimed in claim 14, wherein said associating, recording, generating and outputting modules operate on said server.

21. An activity recordal system as claimed in claim 14, wherein at least one of said monitoring modules is adapted to monitor for occurrence of events on the server and/or at least one of said monitoring modules is adapted to monitor for said commencement and completion of events on a PABX exchange in data communication with the server.

22. (canceled)

23. Computer program code usable to configure a server to implement an activity recordal method, the server being configured to:
receive information relating to events pertaining to one or more activities from at least one monitoring module over a network adapted to monitor for occurrence of said events, said information comprising occurrence times of said respective events;
associate said information relating to said events with respective activities;
record said information relating to said events with data indicative of said respective activities in a database located on the server;
generate reporting data from said information relating to said events recorded in said database; and
output said reporting data.

24. Computer program code usable to configure a user computer to implement an activity recordal method, the user computer being configured to:
receive information relating to events pertaining to one or more activities from at least one monitoring module adapted to monitor for occurrence of said events, said information comprising occurrence times of said respective events;
associate said information relating to said events with respective activities;
record said information relating to said events with data indicative of said respective activities in a database;
generate reporting data from said information relating to said events recorded in said database; and
output said reporting data.

25. (canceled)

26. A computer readable medium comprising computer program code that when executed implements the method of claim 1.

27. (canceled)

28. An activity recordal system as claimed in claim 13, configured to populate a day or other work period by recording said occurrence times of said respective events occurring in the day or other work period with data indicative of said respective activities.
